(19) United States
(12) Patent Application Publication
(10) Pub. No.: US 2026/0115941 A1
(43) Pub. Date: Apr. 30, 2026

(54) ROBOT APPARATUS

(71) Applicant: Samsung Electronics Co., Ltd., Suwon-si (KR)

(72) Inventors: Junghoon PARK, Suwon-si (KR); Donghan Koo, Suwon-si (KR); Jaehong Kim, Suwon-si (KR); Donghyun Kim, Suwon-si (KR); Jinwoong Kim, Suwon-si (KR); Gyowook Shin, Suwon-si (KR)

(73) Assignee: SAMSUNG ELECTRONICS CO., LTD., Suwon-si (KR)

(21) Appl. No.: 19/380,369

(22) Filed: Nov. 5, 2025

Related U.S. Application Data
(63) Continuation of application No. PCT/KR2025/011455, filed on Jul. 31, 2025.

(30) Foreign Application Priority Data
Oct. 29, 2024 (KR) 10-2024-0149867

(51) Int. Cl. B25J 19/00; B25J 9/10

(52) U.S. Cl. CPC B25J 19/0075; B25J 9/106

(57) ABSTRACT

A robot apparatus includes a main body; and a protection device on the main body, the protection device including at least one linkage that is configured to absorb an impact of an external object to the main body, wherein the at least one linkage includes: at least one fixed frame; and a plurality of link structures respectively including a plurality of links connected to each other and the at least one fixed frame such that the plurality of links extend in a zigzag shape, and wherein the plurality of link structures are configured to absorb the impact by a connection angle, between links among the plurality of links of at least one link structure among the plurality of link structures, changing according to an intensity of the impact of the external object with respect to an area of the protection device that includes the at least one link structure.

### CROSS-REFERENCE TO RELATED APPLICATIONS

This application is a bypass continuation of International Patent Application No. PCT/KR2025/011455, filed on Jul. 31, 2025, which claims priority to Korean Patent Application No. 10-2024-0149867, filed in the Korean Intellectual Property Office on Oct. 29, 2024, the disclosures of which are incorporated herein by reference in their entireties.

### BACKGROUND

### 1. Field

Some embodiments of the present disclosure relate to a robot apparatus including a protection device for reducing external impact.

### 2. Description of Background Art

With developments in robot technology, research and development of various robot apparatuses that substitute humans in various places such as shops, cafes, and restaurants are actively underway. These robot apparatuses include humanoid robots that drive and operate on their own without separate user manipulation, and technology is being developed toward raising autonomy.

### SUMMARY

However, problems such as a robot apparatus receiving impact from an external object or the environment while operating and the robot apparatus being damaged may arise. Accordingly, there is a need to develop a structure for the robot apparatus to withstand interactions with various obstacles and operate stably.

According to at least one embodiment of the present disclosure, a robot apparatus may include: a main body; and a protection device on an outer side surface of the main body, the protection device including at least one linkage that is configured to absorb an impact of an external object to the main body, wherein the at least one linkage includes: at least one fixed frame; and a plurality of link structures respectively including a plurality of links connected to each other and the at least one fixed frame such that the plurality of links extend in a zigzag shape, and wherein the plurality of link structures are configured to absorb the impact by a connection angle, between links among the plurality of links of at least one link structure among the plurality of link structures, changing according to an intensity of the impact of the external object with respect to an area of the protection device that includes the at least one link structure.

According to at least one embodiment of the present disclosure, a protection device may include: a coupling frame coupleable to an outer side surface of a target of protection; a plurality of linkages connected to the coupling frame, wherein each of the plurality of linkages includes: at least one fixed frame; a plurality of link structures, the plurality of link structures respectively including a plurality of links connected each other and the at least one fixed frame such that the plurality of links extend in a zigzag shape, and wherein the plurality of link structures are configured to absorb an impact of an external object by a connection angle, between links among the plurality of links of at least one link structure among the plurality of link structures, changing according to an intensity of the impact with respect to an area of the protection device that includes the at least one link structure.

According to at least one embodiment of the present disclosure, a protection device may include: at least one linkage that is configured to absorb an impact of an external object, wherein the at least one linkage includes: at least one fixed frame; and a plurality of link structures respectively including a plurality of links connected to each other and the at least one fixed frame such that the plurality of links extend in a zigzag shape, and wherein the plurality of link structures are configured to absorb the impact by a connection angle, between links among the plurality of links of at least one link structure among the plurality of link structures, changing according to an intensity of the impact of the external object with respect to an area of the protection device that includes the at least one link structure.

### BRIEF DESCRIPTION OF DRAWINGS

FIG. 1 is a perspective diagram illustrating a robot apparatus according to at least one embodiment of the present disclosure;

FIG. 2A is a diagram illustrating a structure of a protection device according to at least one embodiment of the present disclosure;

FIG. 2B is a diagram illustrating a structure of a protection device according to at least one embodiment of the present disclosure;

FIG. 3 is a diagram illustrating at least one linkage according to at least one embodiment of the present disclosure;

FIG. 4A, FIG. 4B, and FIG. 4C are diagrams illustrating an operation of at least one linkage according to at least one embodiment of the present disclosure;

FIG. 5 is a diagram illustrating at least one linkage according to at least one embodiment of the present disclosure;

FIG. 6A is a diagram illustrating at least one linkage according to at least one embodiment of the present disclosure;

FIG. 6B is a diagram illustrating at least one linkage according to at least one embodiment of the present disclosure; and

FIG. 7 is a diagram illustrating an impact absorption member according to at least one embodiment of the present disclosure.

### DETAILED DESCRIPTION

Example embodiments of the present disclosure and terms used in the present disclosure are not intended to limit the present disclosure, and it is to be understood that the present disclosure includes various modifications, equivalents, and alternatives of the corresponding example embodiments.

With respect to the descriptions of the drawings, like reference numerals may be used to indicate like elements.

A singular form of a noun corresponding to an item may include one or a plurality of items above, unless otherwise specified.

In the present disclosure, phrases such as “A or B,” “at least one of A and B,” “at least one of A or B,” “A, B, or C,” “at least one of A, B, and C,” and “at least one of A, B, or C” may respectively include any one or all possible combinations of the items listed together with the relevant phrase from among the phrases.

The term “and/or” may include a combination of a plurality of associated elements described or any element from among the plurality of associated elements described.

Terms such as “1st,” “2nd,” or “first” or “second” may be used to simply distinguish a relevant element from another relevant element, and not limit the relevant elements in other aspects (e.g., importance or order).

When a certain (e.g., first) element is indicated as being “coupled with/to” or “connected to” another (e.g., second) element, together with or without terms such as “operatively” or “communicatively,” it may be understood as the certain element being coupled with/to the another element directly (e.g., via wire), wirelessly, or through a third element.

It is to be understood that terms such as “include,” “comprise,” or “have” are used herein to designate a presence of a characteristic, number, step, operation, element, component, or a combination thereof, and not to preclude a presence or a possibility of adding one or more of other characteristics, numbers, steps, operations, elements, components or a combination thereof.

When a certain element is described as “coupled,” “combined,” “supported,” or “contacted” with another element, the above may include not only the elements being directly coupled, combined, supported, or contacted, but also being indirectly coupled, combined, supported, or contacted through the third element.

When the certain element is described as positioned “on” another element, the above may include not only the certain element being contacted to another element, but also other element being present between the two elements.

An electronic apparatus (e.g., a robot apparatus 1) according to various embodiments will be described in detail below with reference to the drawings.

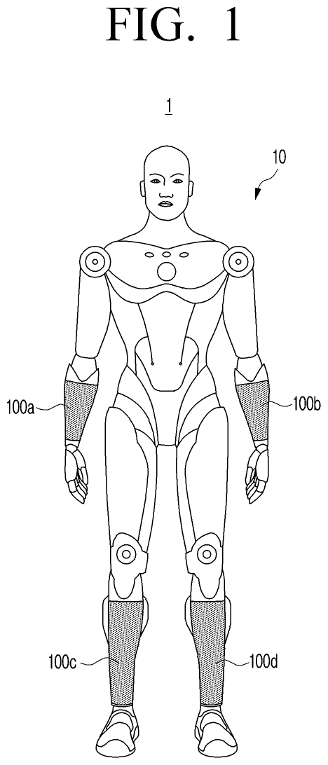

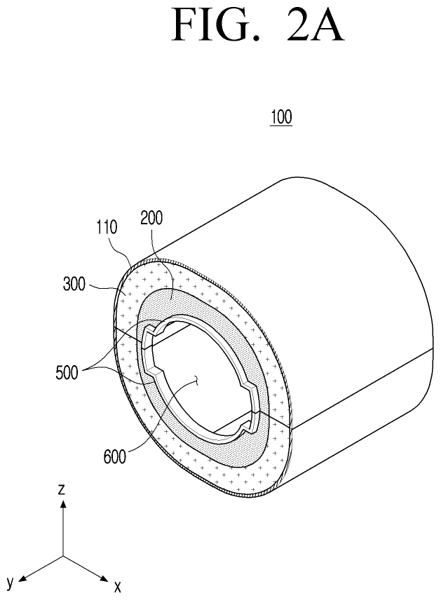

FIG. 1 is a perspective diagram illustrating a robot apparatus 1 according to an embodiment of the present disclosure.

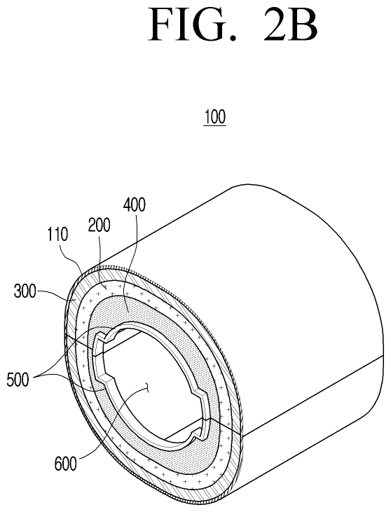

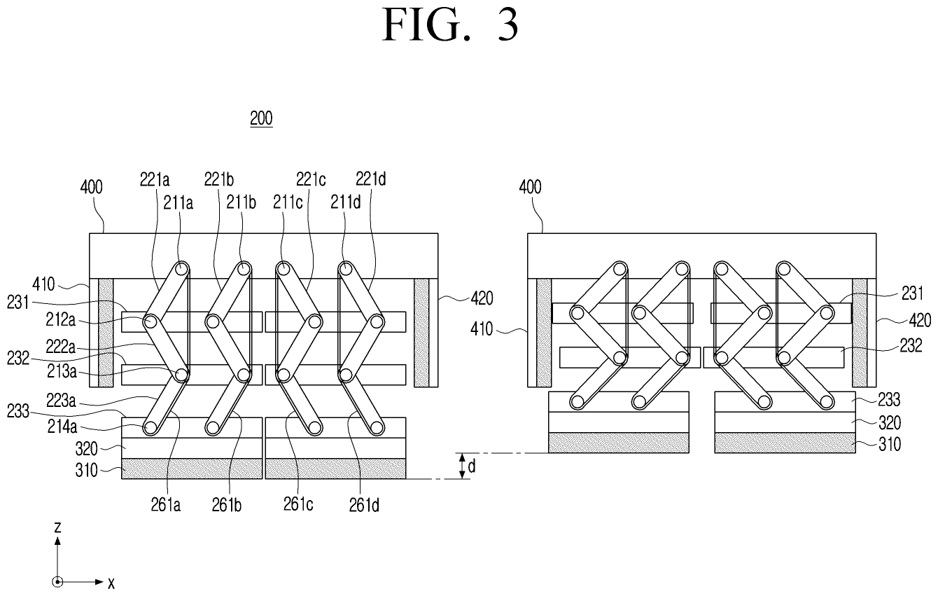

In FIG. 1, the robot apparatus 1 may include a main body 10 and a protection device 100 (see FIGS. 2A and 2B). While the robot apparatus 1 is performing a task or operation, an external force or impact may be applied to the robot apparatus 1 according to an external environment. The protection device 100 may include a structure with which the above-described external force or impact can be absorbed, and may be a device for preventing damage to the robot apparatus 1. The protection device 100 may perform not only a role of absorbing the impact applied to the robot apparatus 1, but also various roles such as, for example, and without limitation, wear prevention, electric protection, structural support, heat protection, and the like. For example, because the protection device 100 is attached to an outer side of the main body 10, wear of frame may be prevented due to parts of the main body 10 that directly contact with the outside being reduced. If an insulation member such as rubber is included in the protection device 100, internal devices of the robot apparatus 1 formed of a metal member may be electrically protected. If the main body 10 is directly coupled to the protection device 100 without an external frame, the robot apparatus 1 may be structurally supported by the protection device 100. If the protection device 100 includes an insulation member or a heat radiating coating, the protection device 100 may minimize heat being transferred from the outside to a key component. In addition, the protection device 100 may be coupled to an outer side surface of the main body 10, and may absorb impact to the main body using at least one linkage 200 (see FIGS. 2A and 2B).

In FIG. 1, the robot apparatus 1 may include the main body 10. The protection device 100 may be coupled to the outer side surface of the main body 10. For example, in the robot apparatus 1 of FIG. 1, a first protection device 100a and a second protection device 100b may be arranged at outer side surfaces of frames of arms of the main body 10. A third protection device 100c and a fourth protection device 100d may be arranged at outer side surfaces of frames of calves of the main body 10. However, the parts to which the protection devices 100 are coupled are not limited thereto, and may be arranged in various forms at various positions such as, for example, and without limitation, knees of the robot apparatus 1, a torso of the robot apparatus 1, and the like.

The main body 10 may be divided into a plurality of parts, the protection device 100 may be coupled to at least one part from among the plurality of parts in an attachable or detachable form, and the protection device 100 may include a plurality of linkages which may be arranged in parallel to surround an outer circumferential surface of the parts.

The first protection device 100a and the second protection device 100b may protect motors or joints arranged inside the main body 10 from impacts that can occur while the robot apparatus 1 is lifting an object or transporting an object. The third protection device 100c and the fourth protection device 100d may protect motors or joints arranged inside the main body 10 from impacts that can occur while the robot apparatus 1 is transporting an object, or moving to a specific location according to the external environment.

Although to some embodiments, the protection device 100 may be coupled to a body unit of the robot apparatus 1. The body unit of the robot apparatus 1 may include many devices for operating the robot. For example, the body unit may include various devices such as, for example, and without limitation, a control unit (e.g., a controller) such as a central processing unit (CPU), an actuator (e.g., a motor) which moves each part of the robot apparatus 1, a power supply device (e.g., battery) which provides energy to the robot apparatus 1, various sensor devices which are in charge of a cognitive ability of the robot apparatus 1, a communication module with which data exchange with an external device or other robots is possible, and the like. In this case, there is a need for the body unit of the robot apparatus 1 to be protected from external impact. Accordingly, the protection device 100 may be coupled with the body unit of the robot apparatus 1 and protect internal devices of the robot apparatus 1.

FIG. 2A and FIG. 2B are diagrams illustrating a structure of the protection device 100 according to at least one embodiment of the present disclosure.

In FIG. 2A and FIG. 2B, the protection device 100 may include an external frame 110, a linkage 200, an impact absorption member 300, coupling parts 500, and a coupling hole 600. The protection device 100 of FIG. 2B may be in a form that further includes an internal frame 400 in the configuration shown in FIG. 2A.

The external frame 110 may be arranged at an outermost side of the protection device 100. The external frame 110 may support all components arranged inside of the protection device 100. The external frame 110 may maintain an exterior shape of the protection device 100 if impact to the protection device 100 has not occurred.

The linkage 200 may be a device which can absorb the impact generated by an external object. The linkage 200 may include a plurality of link structures and at least one fixed frame. The plurality of link structures may be sequentially arranged based on a direction of contact with the outer side surface of the main body 10. The at least one fixed frame may connect the plurality of link structures in zigzag directions. A detailed description thereof will be provided below with reference to FIG. 3. The linkage 200 has been described as a device including the plurality of link structures, but the linkage 200 may be referred to as a linkage including a pair of link structures. In this case, linkages including pairs of link structures may be formed in plurality in a parallel arrangement.

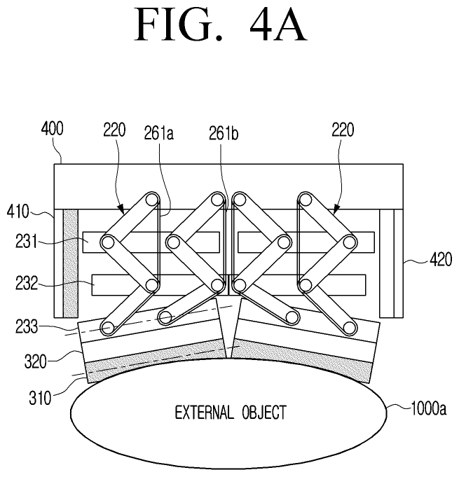

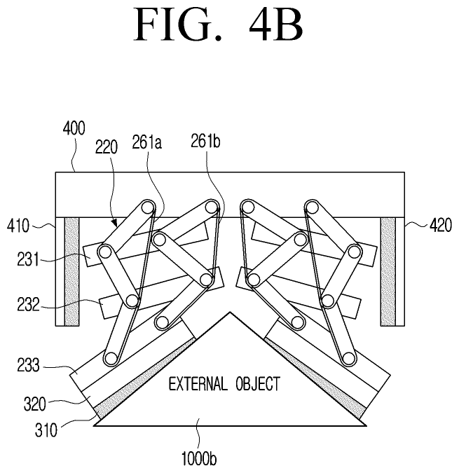

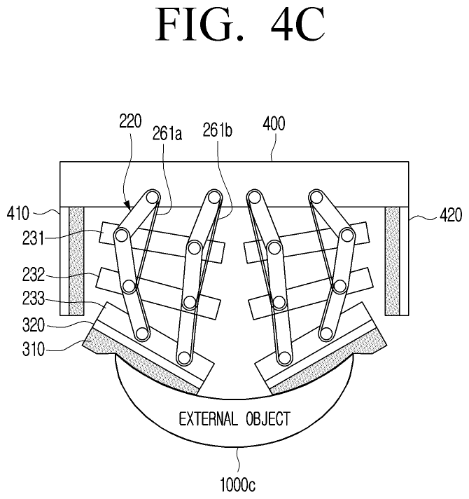

A connection angle between two link structures adjacent to each other from among the plurality of link structures of the linkage 200 may absorb impact while being changed according to an impact position, an impact area, a degree of impact, and an intensity of impact of the external object with respect to the protection device 100. A detailed description for the above will be provided below with reference to FIG. 4A to FIG. 4C.

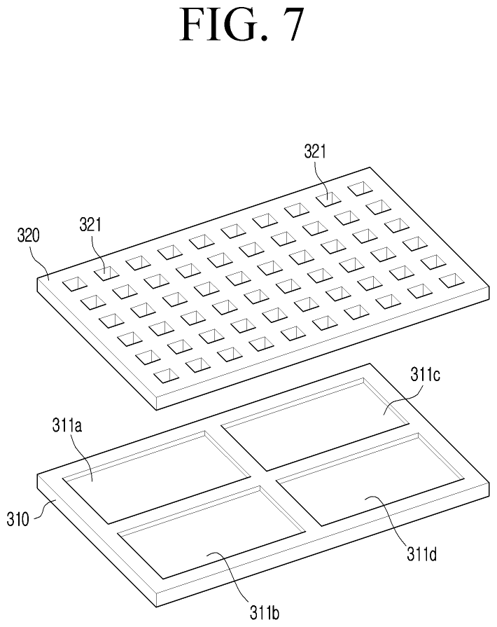

The impact absorption member 300 may be included between the external frame 110 and the linkage 200. The impact absorption member 300 has been described as separate from the linkage 200, but is not limited thereto, and may be in a structured formed integrally with the linkage 200. The impact absorption member 300 may be an elastic body. For example, the impact absorption member 300 may include at least one from among various materials such as rubber, silicon, ethylene propylene diene monomer (EPDM), and polyurethane. Descriptions of a structure and a configuration of the impact absorption member 300 will be provided below with reference to FIG. 3 and FIG. 7.

In FIG. 2A and FIG. 2B, the coupling parts 500 may be coupled respectively define an upper side and a lower side of the coupling hole 600 arranged inside of the protection device 100. However, embodiments of the present disclosure are not limited thereto, and the coupling parts 500 may be arranged integrally so as to define an inner side surface of the coupling hole 600. The coupling parts 500 may be bound to the outer side surface of the main body 10 such that the main body 10 of the robot apparatus 1 is in the coupling hole 600 and coupled to the coupling parts 500. The coupling parts 500 may be coupled to the main body 10 through screw coupling, and may be coupled through welding. The coupling method is not limited to the methods described above, and the coupling parts 500 may be coupled to the main body 10 through various other methods. A cross-section of the coupling hole 600 may be a shape that corresponds to an exterior shape of a target of protection.

The coupling hole 600 may be arranged at a center part of the protection device 100. A shape of the coupling hole 600 may be the same as a shape of the main body 10 of the robot apparatus 1. For example, if the protection device 100 is coupled to a robot arm of the main body 10, the shape of the coupling hole 600 may be the same as a shape of an outer side surface part of the robot arm. If the protection device 100 is coupled to a robot leg of the main body 10, the shape of the coupling hole 600 may be the same as a shape of an outer side surface part of the robot leg. If the protection device 100 is coupled to a torso part of the main body 10, the shape of the coupling hole 600 may be the same as a shape an outer side surface part of the torso part. Here, the robot apparatus 1 may be otherwise referred to as the target of protection.

In FIG. 2B, the internal frame 400 may be arranged inside of the linkage 200 of the protection device 100. The internal frame 400 may support the linkage 200 and the impact absorption member 300 arranged toward the outer side of the linkage 200. The internal frame 400 may be formed with the coupling hole 600 at an inner side thereof. The internal frame 400 may be formed integrally with the linkage 200, or formed as separate devices. Here, the internal frame 400 may be otherwise referred to as a coupling frame. The coupling frame may also be in a form that refers to the combination of the coupling parts 500 and the internal frame 400. However, embodiments of the present disclosure are not limited thereto, and the coupling frame may refer to just the coupling parts 500 alone. If the coupling frame is formed by the internal frame 400, a plurality of linkages 200 may be connected to the coupling frame. The coupling frame may also be in a cylinder shape formed with the coupling hole for receiving an outer circumferential surface of the target of protection.

FIG. 3 is a diagram illustrating the linkage 200 according to at least one embodiment of the present disclosure.

With reference to FIG. 3, the linkage 200 may be associated with the internal frame 400, and may include a plurality of link structures 220 (see FIG. 4A), and may be further associated with an impact absorption member 300. In FIG. 3, unlike as in FIG. 2B, the linkage 200 will be described based on the device included with the internal frame 400 and even the impact absorption member 300. Here, the plurality of link structures may be referred to as at least one linkage. In this case, the linkage 200 may be a configuration including a set relationship of the at least one linkage.

With reference to FIG. 3, the internal frame 400 may support the plurality of link structures 220 (see FIG. 4A). The internal frame 400 may include buffer parts 410 and 420 protruded from both ends of a body of the internal frame 400 toward a direction of the plurality of link structures 220 (see FIG. 4A). If a plurality of the linkages 200 are arranged in parallel, the buffer parts 410 and 420 may be members which can block collision between the linkages 200. The buffer parts 410 and 420 may include a flexible material. For example, various flexible materials such as rubber, silicon, and polyurethane may be included. If the plurality of link structures receive external force and abut with the buffer parts 410 and 420, the buffer parts 410 and 420 may prevent damage to a plurality of links through the flexible material.

With reference to FIG. 3, the plurality of link structures may be arranged at a lower side of the internal frame 400. Alternatively, the at least one linkage 200 may be arranged at the lower side of the internal frame 400. Here, the plurality of link structures being arranged at the lower side of the internal frame 400 has been expressed as above for convenience of description, and a plurality of link structures may be arranged in a parallel arrangement toward an outer side direction of the internal frame 400. In other words, the plurality of linkages may be arranged in parallel along an outer circumferential surface of the coupling frame.

With reference to FIG. 3, the plurality of link structures may be sequentially arranged based on a direction of contact with the outer side surface of the main body 10. In other words, the plurality of link structures may be arranged in parallel based on the direction of contact with the outer side surface of the main body 10. The plurality of link structures may be a structure in which each of links of the link structures are connected in zigzag directions. A connection angle between two link structures adjacent to each other from among the plurality of link structures may absorb impact by being changed according to the impact position, the impact area, and the degree of impact of the external object with respect to the protection device 100. A detailed description thereof will be provided below with reference to FIG. 4A to FIG. 4C.

With reference to FIG. 3, the plurality of link structures may include a plurality of first links 221a, 221b, 221c, and 221d, a plurality of second links 222a, a plurality of third links 223a, a plurality of first joints 211a, 211b, 211c, and 211d (e.g., hinges), a plurality of second joints 212a (e.g., hinges), a plurality of third joints 213a (e.g., hinges), and a plurality of fourth joints 214a (e.g., hinges), and an elastic body 261a, 261b, 261c, and 261d. The linkage 200 may further include at least one fixed frame (e.g., a first fixed frame 231, a second fixed frame 232, and a third fixed frame 233). Configurations of the plurality of second links 222a and the plurality of third links 223a may be the same as a configuration of the plurality of first links 221a, 221b, 221c, and 221d, and therefore repeated descriptions thereof may be omitted. Configurations of the plurality of second joints 212a, the plurality of third joints 213a, and the plurality of fourth joints 214a may be the same as a configuration of the plurality of first joints 211a, 211b, 211c, and 211d, and therefore repeated descriptions thereof may be omitted.

The plurality of link structures may be formed as a windlass structure which is modified according to the impact position, the impact area, and the degree of impact of the external object. The windlass structure may refer to a form forming an arch shape using a first link (e.g., first link 221a, 221b, 221c, or 221d), a second link 222a, a third link 223a, and an elastic body 261a. The linkage 200 may include a plurality of the windlass structure. The windlass structure described above may absorb and distribute impact applied to the robot apparatus 1 when external force is applied to the robot apparatus 1. The protection device 100 may increase, due to the windlass structure being applied, force transmission efficiency compared to when using a typical spring, and reduce size and weight thereof. In addition, the linkage 200 may increase, due to the windlass structure being applied, durability because wear or fatigue may likely occur less compared to springs or other elastic components are used. In addition, the linkage 200 may adjust, due to the windlass structure being applied, flexibility and precision of the plurality of link structures by adjusting a degree of joint tightening between joints between the links. Based on the above, the at least one linkage 200 may include a plurality of link structures including a plurality of links connected in zigzag directions through the fixed frames.

The plurality of first links 221a, 221b, 221c, and 221d may be coupled with the internal frame 400 through the plurality of first joints 211a. A portion (e.g., the first links 221a and 221b) from among the plurality of first links 221a, 221b, 221c, and 221d may be arranged to extend in a left diagonal direction with respect to the internal frame 400, and a remaining portion (e.g., the first links 221c and 221d) from among the plurality of first links 221a, 221b, 221c, and 221d may be arranged toe extend in a right diagonal direction with respect to the internal frame 400. However, embodiments of the present disclosure are not limited thereto, and the plurality of first links 221a, 221b, 221c, and 221d may be freely arranged to extend in the left or right diagonal directions with respect to the internal frame 400. Accordingly, the plurality of first links 221a, 221b, 221c, and 221d may be pivoted about a respective first joint 211a, 211b, 211c, and 211d.

The plurality of first links 221a, 221b, 221c, and 221d and the internal frame 400 may be coupled through a slot. Here, the slot may be an elongated hole shape in the internal frame 400 that extends in a length direction of the internal frame 400. Accordingly, if the plurality of link structures receives an impact by an external object, each link of the plurality of link structures may flexibly operate according to a shape of the external object.

With reference to FIG. 3, the plurality of second links 222a may be coupled with a plurality of first links 221a through a plurality of second joints 212a. In order for the plurality of link structures to be arranged in zigzag directions, the plurality of second links 222a may extend in an opposite diagonal direction from an extension direction of the plurality of first links 221a, 221b, 221c, and 221d. For example, if a portion (e.g., the first link 221a) from among the plurality of first links extends in the left diagonal direction from the lower side of the internal frame 400, the second link 222a coupled with the portion (e.g., the first link 221a) from among the plurality of first links may extend in the right diagonal direction from the lower side of the portion (e.g., the first link 221a) from among the plurality of first links. Unlike the above, if a portion (e.g., the first link 221c) from among the plurality of first links extends in the right diagonal direction from the lower side of the internal frame 400, the second link 222a coupled with the portion (e.g., the first link 221c) from among the plurality of first links may extend in the left diagonal direction from the lower side of the portion (e.g., the first link 221c). The plurality of second links 222a may be pivoted about the plurality of second joints 212a. That is, the plurality of second links 222a may rotate in a clockwise direction or an anti-clockwise direction around a rotational axis extending through a front surface of the second links 222a.

The plurality of third links 223a may be coupled with the plurality of second links 222a through a plurality of third joints 213a. The plurality of third links 223a may be extend in the opposite diagonal direction from the plurality of second links 222a based on the third joint part 213a in order for the plurality of link structures to be connected in zigzag directions. Because an example has been described in detail in the above-described portion, repeated descriptions thereof may be omitted.

The at least one fixed frame (e.g., the first fixed frame 231, the second fixed frame 232, and the third fixed frame 233) may be coupled with the plurality of second joints 212a, the plurality of third joints 213a, and the plurality of fourth joints 214a, respectively. A fixed frame coupled with the plurality of second joints 212 from among the at least one fixed frame may be referred to as a first fixed frame 231, a fixed frame coupled with the plurality of third joints 213 from among the fixed frames may be referred to as a second fixed frame 232, and a fixed frame coupled with the plurality of fourth joints 214a from among the fixed frames may be referred to as a third fixed frame 233.

The at least one fixed frame (e.g., the first fixed frame 231, the second fixed frame 232, and the third fixed frame 233) may perform a role of fixing the plurality of links by connecting the plurality of link structures in zigzag directions through each joint. In addition, the at least one fixed frame (e.g., the first fixed frame 231, the second fixed frame 232, and the third fixed frame 233) may improve the durability of the plurality of link structures by coupling a portion from among the plurality of link structures together therewith. Here, the at least one linkage 200 may be formed as a plurality of layer shapes due to the at least one fixed frame (e.g., the first fixed frame 231, the second fixed frame 232, and the third fixed frame 233) being coupled with each of the links.

In FIG. 3, the first fixed frame 231 may be coupled with the plurality of first links (e.g., the first links 221a, 221b, 221c, and 221d) and the plurality of second links 222a through the plurality of second joints 212a. The first fixed frame 231 may be connected to two first links 221a and 221b and two second links 222a by two of the second joints 212a. In addition, the first fixed frame 231 may be connected remaining links (e.g., the first links 221c and 221d) from among the plurality of first 221a and the remaining links (e.g., seconds links 22a) from among the plurality of second links 222a by others of the second joints 212a.

The second fixed frame 232a may be coupled with the plurality of second links 222a and the plurality of third links 223a by the plurality of third joints 213a. The plurality of second links 222a and the plurality of third links 223a may be coupled with areas of the second fixed frame 232 that are different from areas at which the plurality of first links 221a, 221b, 221c, and 221d and the plurality of second links 222a are coupled with the first fixed frame 231. For example, the area at which the plurality of first links 221a, 221b, 221c, and 221d and the plurality of second links 222a are coupled with the first fixed frame 231 may be a left side portion or a center part portion of the first fixed frame 231. Conversely, an area at which the first link 221a and one from among the plurality of second links 222a are coupled with the first fixed frame 231 may be the center part portion or a right side portion of the second fixed frame 232. The third fixed frame 233 may be coupled with the plurality of third links 223a by the plurality of fourth joints 214. Because the first fixed frame 231, the second fixed frame 232, and the third fixed frame 233 are coupled with the plurality of first links (e.g., the first links 221a, 221b, 221c, and 221d), the plurality of second links 222a, and the plurality of third links 223a in zigzag directions with one another, the above may be arranged at different positions from one another with respect to each of the fixed frames.

At least one elastic body (e.g., the elastic body 261a, 261b, 261c, and 261d) may be coupled to the plurality of first links 221a, 221b, 221c, and 221d and the plurality of third links 223a. Specifically, one side of the at least one elastic body (e.g., the elastic body 261a, 261b, 261c, and 261d) may be coupled to the plurality of first links 221a, 221b, 221c, and 221d, at an area at which the internal frame 400 and the plurality of first links 221a, 221b, 221c, and 221d are coupled through a plurality of first joints (e.g., first joints 211a, 211b, 211c, and 211d). An opposite side of the elastic body (e.g., the elastic body 261a, 261b, 261c, and 261d) may be attached to one surface of the plurality of third links 223a. Accordingly, the elastic body (e.g., the elastic body 261a, 261b, 261c, and 261d), the plurality of first links 221a, 221b, 221c, and 221d, and the plurality of second links 222a may form an arch shape. In addition, the at least one elastic body (e.g., the elastic body 261a, 261b, 261c, and 261d), the plurality of first links 221a, 221b, 221c, and 221d, and the plurality of second links 222a may form a triangle shape. The plurality of link structures capable of showing the arch shape or the triangle shape described above may be referred to as the windlass structure. At least one of the elastic bodies (e.g., the elastic body 261a, 261b, 261c, and 261d) may alternatively be connected with the first links 221a, 221b, 221c, and 221d which contact with the outer side surface of the main body 10 from among the plurality of link structures and the third links 223a which contact with impact absorption members 310 and 320 from among the plurality of link structures. The elastic bodies (e.g., the elastic body 261a, 261b, 261c, and 261d) may be created with one from among various materials such as, for example, and without limitation, rubber, silicon, polyurethane, ethylene propylene diene monomer (EPDM), or the like. The elastic bodies (e.g., the elastic body 261a, 261b, 261c, and 261d) may provide restoring force for the plurality of link structures to be restored to their original places when impact disappears after the plurality of link structures is spread or folded by the impact of the external object.

The impact absorption members (e.g., the impact absorption member 310 and the second impact absorption member 320) may be formed at one side of the windlass structure(s). The impact absorption members (e.g., the impact absorption member 310 and the second impact absorption member 320) may be arranged at a lower side of the third fixed frame 233. The impact absorption members (e.g., the impact absorption member 310 and the second impact absorption member 320) may be formed integrally, or may be formed separately with two different materials as in FIG. 3. For example, a first impact absorption member 310 which contacts with the third fixed frame 233 from among the impact absorption members may be of an expanded polypropylene (EPP) material, and a second impact absorption member 320 which contacts with an outer side of the first impact absorption member 310 may be of rubber material. However, embodiments of the present disclosure are not limited thereto, and the first impact absorption member 310 and the second impact absorption member 320 may be formed with one from among the various flexible materials. Here, the first impact absorption member 310 and the second impact absorption member 320 may otherwise be respectively referred to as a first elastic member which is coupled to one side of the windlass structure, and a second elastic member (e.g., the second impact absorption member 320) which is coupled to the opposite side of the first elastic member. The first elastic member (e.g., the first impact absorption member 310) and the second elastic member (e.g., the second impact absorption member 320) may be formed of different materials from each other. A thickness of the first elastic member (e.g., the first impact absorption member 310) may be thicker than a thickness of the second elastic member (e.g., the second impact absorption member 320). However, embodiments of the present disclosure are not limited thereto, and the thickness of the second elastic member (e.g., the second impact absorption member 320) may be thicker than the thickness of the first elastic member (e.g., the first impact absorption member 310). The first elastic member (e.g., the first impact absorption member 310) may be of a more flexible material than a material of the second elastic member (e.g., the second impact absorption member 320). Accordingly, when a protection device 100 receives impact from the external object, scratching or damage may be prevented when directly contacting with the external object due to the first elastic member (e.g., the first impact absorption member 310) effectively absorbing the impact and firmness of the second elastic member (e.g., the second impact absorption member 320).

With reference to FIG. 3, the protection device 100 (see FIGS. 2A and 2B) may absorb impact when the protection device 100 receives impact from the external object. A connection angle between two link structures adjacent to each other from among the plurality of link structures of the protection device 100 may absorb the impact while being changed according to the impact position, the impact area, the degree of impact, and the intensity of impact of the external object with respect to the protection device 100. When the protection device 100 receives impact from the external device, the plurality of link structures arranged at the lower side of the internal frame 400 and impact absorption members (e.g., the impact absorption member 310 and the second impact absorption member 320) may be raised to an upper side thereof. For example, as shown in FIG. 3, when receiving impact from the external object, the plurality of link structures arranged at the lower side of the internal frame 400, and the impact absorption members (e.g., the impact absorption member 310 and the second impact absorption member 320), may be raised towards the upper side by a distance d. Based on the plurality of link structures of the protection device 100 being raised to towards the upper side by the distance d, impact force of receiving impact from the external object may be reduced. Specifically, the impact force may refer to a value of having divided impact time from an impact amount. Here, based on the plurality of link structures being raised towards the upper side by the distance d, the impact time may increase. Accordingly, the impact force applied to the robot apparatus 1 may be reduced.

FIG. 4A, FIG. 4B, and FIG. 4C are diagrams illustrating operations of a plurality of link structures according to at least one embodiment of the present disclosure. FIG. 4A, FIG. 4B, and FIG. 4C show operations of the plurality of link structures varying respectively according to the shape of the external object.

The above will be described based on one link structure 220 from among the plurality of link structures 220. The above may be referred to as the link structure 220 for convenience of description.

With reference to FIG. 4A, an external object 1000a having an elliptical shape with a convex cross-section is raised from a lower side to an upper side direction thereof, and the link structure 220 is receiving impact by the external object 1000a. The plurality of link structures 220 may be in a form in which a center part thereof is raised according to the elliptical shape of the external object 1000a, and both side parts thereof are descended. That is, the first links, the second links, and the third links of the two link structures 220 arranged at an outer side from among the plurality of link structures 220 may be in a spread form, and the first links, the second links, and the third links of the two link structures 220 arranged at a center part from among the plurality of link structures 220 may be in a folded form. Accordingly, a portion of the third fixed frame 233 arranged at the left side in FIG. 4A may be formed in a diagonal form with a left side part of the portion of the third fixed frame 233 lowered, and a portion of the third fixed frame 233 arranged at the right side in FIG. 4A may be formed in a diagonal form with a right side part of the portion of the third fixed frame 233 is lowered.

With reference to FIG. 4B, an external object 1000b with a cross-section having a isosceles triangle shape is raised from a lower side to an upper side direction thereof, and the link structure 220 is receiving the impact by the external object 1000b. The plurality of link structures 220 may be in a form in which the center part thereof is raised according to the isosceles triangle shape of the external object 1000b, and both side parts thereof are descended. The first links, the second links, and the third links of the two link structures 220 arranged at the outer side from among the plurality of link structures 220 may be in the spread form, and the first links, the second links, and the third links of the two link structures 220 arranged at the center part from among the plurality of link structures 220 may be in the folded form. Accordingly, the portion of the third fixed frame 233 arranged at the left side of FIG. 4A may be formed in the diagonal form with the left side part of the portion of the third fixed frame 233 lowered, and the portion of the third fixed frame 233 arranged at the right side of FIG. 4A may be formed in the diagonal form with the right side part of the portion of the third fixed frame 233 lowered. A diagonal angle of the portions of third fixed frame 233 may be greater than a diagonal angle of the portions of third fixed frame 233 in FIG. 4A.

With reference to FIG. 4C, an external object 1000c with a cross-section having a crescent moon form is raised from a lower side to an upper side direction thereof, and the link structure 220 is receiving the impact by the external object 1000c. The plurality of link structures 220 may be in a form in which the center part thereof is lowered according to a crescent moon shape of the external object 1000c, and both side parts thereof are raised. The first links, the second links, and the third links of the two link structures 220 arranged at the outer side from among the plurality of link structures 220 may be in the folded form, and the first links, the second links, and the third links of the two link structures 220 arranged at the center part from among the plurality of link structures 220 may be in the spread form. Accordingly, the portion of the third fixed frame 233 arranged at the left side in FIG. 4C may be formed in the diagonal form with the left side part of the portion of the third fixed frame 233 raised, and the portion of the third fixed frame 233 arranged at the right side of FIG. 4C may be formed in the diagonal form with the right side part of the portion of third fixed frame 233 raised.

Because the external objects 1000a, 1000b, and 1000c of FIG. 4A, FIG. 4B, and FIG. 4C are shown as subjecting impact to the protection device 100 due to being raised at positions where both sides are symmetrical, connection angles of the plurality of link structures 220 may vary according to the impact positions, the impact areas, the degrees of impact, and the intensities of impact of the external objects 1000a, 1000b, and 1000c.

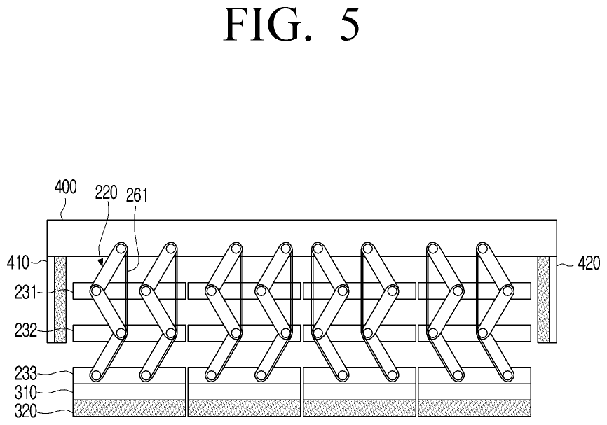

FIG. 5 is a diagram illustrating a plurality of link structures according to at least one embodiment of the present disclosure.

With reference to FIG. 5, the linkage 200 may be a structure with a number of the plurality of link structures 220 is greater than a number of the plurality of link structures 220 of the linkage 200 in FIG. 3. The number of the plurality of link structures 220 of the linkage 200 may vary according to a shape of the main body 10, an attachment position on the main body 10, and the like. The linkage 200 may have a total of eight link structures 220, including four pairs of the link structures 220. In FIG. 5, because structures for each of the plurality of links of the linkage 200 form the same structure as that in FIG. 3, repeated descriptions thereof may be omitted.

With reference to FIG. 5, the linkage 200 may flexibly absorb impact, including large impacts from objects. In FIG. 5, although the fixed frames (e.g., the first fixed frame 231, the second fixed frame 232, and the third fixed frame 233) of the linkage 200 appear as if adjacent to one another, a space may be present between each of the fixed frames (e.g., the first fixed frame 231, the second fixed frame 232, and the third fixed frame 233). Accordingly, even if an angle of a link of the structure is changed by the external impact, the linkage 200 may prevent each of the fixed frames (e.g., the first fixed frame 231, the second fixed frame 232, and the third fixed frame 233) from colliding with one another.

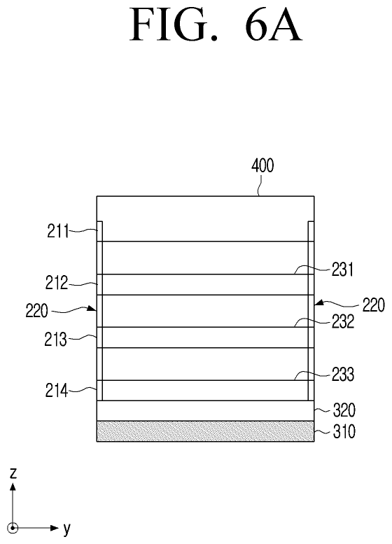

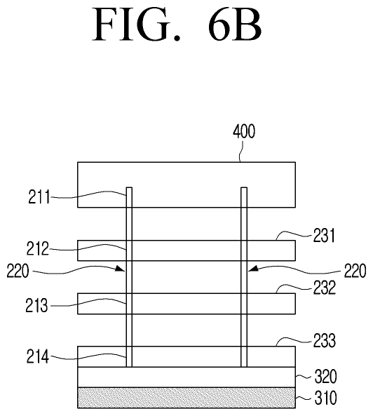

FIG. 6A and FIG. 6B are diagrams illustrating a plurality of link structures according to at least one embodiment of the present disclosure. FIG. 6A and FIG. 6B are side views of the linkage 200 in FIG. 3. That is, FIG. 6A and FIG. 6B are views of the linkage 200 of FIG. 3 viewed from a 90 degree rotated state to the right side.

FIG. 6A shows a plurality of respective links of the linkage 200 being respectively arranged at opposite ends of the internal frame 400 and the fixed frames (e.g., the first fixed frame 231, the second fixed frame 232, and the third fixed frame 233), and FIG. 6B shows the plurality of respective links of the linkage 200 being arranged between the opposite ends of the internal frame 400 and the fixed frames (e.g., the first fixed frame 231, the second fixed frame 232, and the third fixed frame 233). A number of the plurality of respective links of the linkage 200 is not necessarily limited thereto, and the linkage 200 may include additional links at one area between both ends in addition to the links arranged at both ends thereof. Based on the above, the linkage 200 may be configured with a plurality of links including three or more links.

With reference to FIG. 6A and FIG. 6B, a length (e.g., in a horizontal direction) of the fixed frames (e.g., the first fixed frame 231, the second fixed frame 232, and the third fixed frame 233) may be the same as the length (e.g., in the horizontal direction) of the internal frame 400. Unlike as in FIG. 6A and FIG. 6B, a y-axis length of the fixed frames (e.g., the first fixed frame 231, the second fixed frame 232, and the third fixed frame 233) may be shorter compared to a y-axis length of the internal frame 400. The y-axis length of the fixed frames (e.g., the first fixed frame 231, the second fixed frame 232, and the third fixed frame 233) may be the same as a y-axis length of the impact absorption member 300. That is, a y-axis length of the first elastic member (e.g., the first impact absorption member 310) and the second elastic member (e.g., the second impact absorption member 320) may be the same as the y-axis length of the fixed frames (e.g., the first fixed frame 231, the second fixed frame 232, and the third fixed frame 233)

With reference to FIG. 6A and FIG. 6B, the first elastic member (e.g., the first impact absorption member 310) and the second elastic member (e.g., the second impact absorption member 320) may be formed in a form covering the third fixed frame 233. For example, the first elastic member (e.g., the first impact absorption member 310) and the second elastic member (e.g., the second impact absorption member 320) may be on a bottom surface of the third fixed frame 233. Accordingly, the third fixed frame 233 may not be exposed to the outside.

In FIG. 6A and FIG. 6B, four or more link structures may be included in the plurality of link structures. Specifically, the linkage 200 may be formed as two link structures 220 extending in an x-axis direction, and two link structures extending in a y-axis direction. However, a number of linkages 200 is not limited thereto, and the number of linkages 200 may be formed in various numbers and configurations.

In FIG. 6B, because the plurality of link structures of the linkage 200 is arranged between opposite ends of the fixed frames (e.g., the first fixed frame 231, the second fixed frame 232, and the third fixed frame 233), the plurality of link structures 220 may not receive impact directly from the external object. Accordingly, durability of the plurality of link structures 220 may increase.

FIG. 7 is a diagram illustrating the impact absorption member 300 according to at least one embodiment of the present disclosure.

With reference to FIG. 7, the impact absorption member 300 may be arranged at an outer side of the linkage 200. Specifically, the impact absorption member 300 may include the first elastic member (e.g., the first impact absorption member 310) and the second elastic member (e.g., the second impact absorption member 320) which may be coupled at one side of the windlass structure(s) of the linkage 200. The second elastic member (e.g., the second impact absorption member 320) may be coupled to the opposite side of the first elastic member (e.g., the first impact absorption member 310). The first elastic member (e.g., the first impact absorption member 310) and the second elastic member (e.g., the second impact absorption member 320) may be formed of different materials from each other.

In FIG. 7, the first elastic member (e.g., the first impact absorption member 310) may be referred to as an external layer. The second elastic member (e.g., the second impact absorption member 320) may be referred to as an internal layer. The first elastic member (e.g., the first impact absorption member 310) may include four division grooves 311a, 311b, 311c, and 311d at a surface (e.g., upper surface) of the first elastic member (e.g., the first impact absorption member 310) that contacts with the second elastic member (e.g., the second impact absorption member 320). The four division grooves 311a, 311b, 311c, and 311d may be respectively formed to have a same size and shape as each other. Through the four division grooves 311a, 311b, 311c, and 311d, an air layer may be formed between the surface of the first elastic member (e.g., the first impact absorption member 310) and the surface of the second elastic member (e.g., the second impact absorption member 320).

With reference to FIG. 7, the second elastic member (e.g., the second impact absorption member 320) may include a plurality of holes 321. The second elastic member (e.g., the second impact absorption member 320) may distribute the impact generated by the external object through the plurality of holes 321. Accordingly, the plurality of holes 321 may enhance the overall impact absorption of the second elastic member (e.g., the second impact absorption member 320). In addition, as air flow in the second elastic member (e.g., the second impact absorption member 320) may be improved through the plurality of holes 321, discharging internal heat or humidity to the outside may be easily achieved.

The second elastic member (e.g., the second impact absorption member 320) may be formed of an expanded polypropylene (EPP) material. Accordingly, the second elastic member (e.g., the second impact absorption member 320) may exhibit strong resistance to heat applied by impact of the external object. In addition, the second elastic member (e.g., the second impact absorption member 320) may exhibit a superior buffering function against repeated impact by the external object. In addition, because the second elastic member (e.g., the second impact absorption member 320) exhibits high strength and durability, weight lightening may be possible.

Each of the elements described in the present disclosure may be configured with one or more components, and a name of a relevant element may be changed according to a type of the robot apparatus.

In the above, various example embodiments of the present disclosure have been described individually. However, the example embodiments are not limited thereto, and the configuration and operation of the respective embodiments may be implemented in combination with at least one other embodiment (e.g., each other).

While non-limiting example embodiments of the present disclosure have been described above with reference to the accompanying drawings, it will be understood that the embodiments are intended to be illustrative, not limiting. It will be understood by those skilled in the art that various changes in form and details may be made therein without departing from the spirit and scope of the present disclosure.

What is claimed is:

1. A robot apparatus, comprising:
a main body; and
a protection device on an outer side surface of the main body, the protection device comprising at least one linkage that is configured to absorb an impact of an external object to the main body,
wherein the at least one linkage comprises:
at least one fixed frame; and
a plurality of link structures respectively comprising a plurality of links connected to each other and the at least one fixed frame such that the plurality of links extend in a zigzag shape, and
wherein the plurality of link structures are configured to absorb the impact by a connection angle, between links among the plurality of links of at least one link structure among the plurality of link structures, changing according to an intensity of the impact of the external object with respect to an area of the protection device that includes the at least one link structure.

2. The robot apparatus of claim 1, wherein
the plurality of link structures are respectively in a form of a windlass structure that is configured to be modified according to an impact position, an impact area, and a degree of the impact of the external object, and
the at least one linkage further comprises an impact absorption member, and
the plurality of link structures are between the main body and the impact absorption member.

3. The robot apparatus of claim 2, wherein the plurality of link structures further comprise:
at least one elastic body connected to at least one link from among the plurality of links, and the at least one elastic body is configured to change shape based on the impact of the external object.

4. The robot apparatus of claim 3, wherein
the protection device further comprises an internal frame that contacts an outer side surface of the main body, and
wherein the plurality of links of the at least one link structure comprises:
a first link connected to the internal frame;
a second link connected to the first link and a first fixed frame, among the at least one fixed frame, by a first joint; and
a third link connected to the second link and a second fixed frame, among the at least one fixed frame, by a second joint, and
wherein the at least one elastic body is connected to the first link and the third link.

5. The robot apparatus of claim 1, wherein
the main body comprises a plurality of parts,
the protection device is connected to at least one part from among the plurality of parts and is configured to be detached from the at least one part, and
the at least one linkage comprises a plurality of linkages that are arranged parallel to each other such as to surround an outer circumferential surface of the at least one part.

6. The robot apparatus of claim 2, wherein
the impact absorption member comprises:
a first elastic member on one side of the windlass structure; and
a second elastic member,
wherein the first elastic member is between the windlass structure and the second elastic member, and the second elastic member comprises material different from a material the first elastic member.

7. The robot apparatus of claim 6, wherein
the material of the first elastic member comprises an expanded polypropylene (EPP) material.

8. The robot apparatus of claim 6, wherein
a thickness the first elastic member is thicker than a thickness of the second elastic member.

9. A protection device, comprising:
a coupling frame coupleable to an outer side surface of a target of protection;
a plurality of linkages connected to the coupling frame,
wherein each of the plurality of linkages comprises:
at least one fixed frame;
a plurality of link structures, the plurality of link structures respectively comprising a plurality of links connected each other and the at least one fixed frame such that the plurality of links extend in a zigzag shape, and
wherein the plurality of link structures are configured to absorb an impact of an external object by a connection angle, between links among the plurality of links of at least one link structure among the plurality of link structures, changing according to an intensity of the impact with respect to an area of the protection device that includes the at least one link structure.

10. The protection device of claim 9, wherein
the coupling frame comprises a cylinder shape, wherein the cylinder shape includes a hole that is configured to receive an outer circumferential surface of the target of protection,
a cross-sectional shape of the hole corresponds to a shape of an exterior of the target of protection, and
the plurality of linkages are arranged in parallel to each other along an outer circumferential surface of the coupling frame.

11. The protection device of claim 9, wherein
the plurality of link structures are respectively in a form of a windlass structure that is configured to be modified according to an impact position, an impact area, and a degree of the impact of the external object,
the plurality of linkages further comprise an impact absorption member, and
the plurality of link structures are between the coupling frame and the impact absorption member.

12. The protection device of claim 11, further comprising:
an elastic body at connected to at least one link from among the plurality of links, and the elastic body is configured to change shape based on the impact of the external object.

13. The protection device of claim 12, wherein
the plurality of links of the at least one link structure comprises:
a first link connected to the coupling frame;
a second link connected to the first link; and
a third link connected to the first link by the second link,
the first link, the second link, and the third link are between the coupling frame and the impact absorption member, and
the elastic body is connected to the first link, the second link, and the third link.

14. The protection device of claim 11, wherein
the impact absorption member comprises:
a first elastic member on one side of the windlass structure; and
a second elastic member,
wherein the first elastic member is between the windlass structure and the second elastic member, and the second elastic member comprises material different from a material the first elastic member.

15. The protection device of claim 14, wherein
the material of the first elastic member comprises an expanded polypropylene (EPP) material.

16. A protection device, comprising:
at least one linkage that is configured to absorb an impact of an external object,
wherein the at least one linkage comprises:
at least one fixed frame; and
a plurality of link structures respectively comprising a plurality of links connected to each other and the at least one fixed frame such that the plurality of links extend in a zigzag shape, and
wherein the plurality of link structures are configured to absorb the impact by a connection angle, between links among the plurality of links of at least one link structure among the plurality of link structures, changing according to an intensity of the impact of the external object with respect to an area of the protection device that includes the at least one link structure.

17. The protection device of claim 16, wherein
the plurality of link structures are respectively in a form of a windlass structure that is configured to be modified according to an impact position, an impact area, and a degree of the impact of the external object, and
the at least one linkage further comprises an impact absorption member, and
the plurality of link structures are between the main body and the impact absorption member.

18. The robot apparatus of claim 17, wherein the plurality of link structures further comprise:
at least one elastic body connected to at least one link from among the plurality of links, and the at least one elastic body is configured to change shape based on the impact of the external object.

19. The protection device of claim 18, further comprising:
an internal frame,
wherein the plurality of links of the at least one link structure comprises:
a first link connected to the internal frame;
a second link connected to the first link and a first fixed frame, among the at least one fixed frame, by a first joint; and
a third link connected to the second link and a second fixed frame, among the at least one fixed frame, by a second joint, and
wherein the at least one elastic body is connected to the first link and the third link.

20. The protection device of claim 16, wherein
the at least one linkage comprises a plurality of linkages that are arranged parallel to each other.
